(19) United States
(12) Patent Application Publication
(10) Pub. No.: US 2023/0206556 A1
(43) Pub. Date: Jun. 29, 2023

(54) METHOD OF PROCESSING MAP DATA, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Daochen CHONG, Beijing (CN); Feng TIAN, Beijing (CN); Baofeng MA, Beijing (CN); Yao LUO, Beijing (CN); Tianxiong DUAN, Beijing (CN); Xingtao WANG, Beijing (CN); Bu WANG, Beijing (CN); Yuqi XIA, Beijing (CN); Yuting LIU, Beijing (CN)

(73) Assignee: BEIJING BAIDU NETCOM SCIENCE TECHNOLOGY CO., LTD., Beijing (CN)

(21) Appl. No.: 18/116,571

(22) Filed: Mar. 2, 2023

(30) Foreign Application Priority Data
Mar. 7, 2022 (CN) 202210217803.7

(51) Int. Cl. G06T 17/05; G06T 7/174; G06T 7/70; G06T 17/20

(52) U.S. Cl. CPC G06T 17/05; G06T 7/174; G06T 7/70; G06T 17/205; G06T 2207/10028; G06T 2207/30236; G06T 2207/30244; G06T 2207/30252; G06T 2210/56; G06T 2207/20021

(57) ABSTRACT

A method of processing map data, an electronic device, and a storage medium, which relate to a field of a computer technology, in particular to fields of intelligent transportation technology, image processing technology, etc. The method of processing the map data includes: processing sensor data for a traffic object to obtain point cloud data for the traffic object, where the sensor data includes image data; obtaining mesh data based on the point cloud data; processing the image data based on an association between the mesh data and the image data, so as to obtain processed image data; and obtaining the map data for the traffic object based on the processed image data.

This application claims priority to Chinese Patent Application No. 202210217803.7, filed on Mar. 7, 2022, the entire contents of which is incorporated herein in its entirety by reference.

### TECHNICAL FIELD

The present disclosure relates to a field of a computer technology, in particular to fields of intelligent transportation technology, image processing technology, etc., and more specifically, to a method of processing map data, an electronic device, and a storage medium.

### BACKGROUND

An electronic map is used in various fields of life and plays an important role in life. In related art, producing a map has a high production cost, a low accuracy, and a poor production effect, so that a use effect of the electronic map may be affected.

### SUMMARY

The present disclosure provides a method of processing map data, an electronic device, and a storage medium.

According to an aspect of the present disclosure, a method of processing map data is provided, including: processing sensor data for a traffic object to obtain point cloud data for the traffic object, wherein the sensor data includes image data; obtaining mesh data based on the point cloud data; processing the image data based on an association between the mesh data and the image data, so as to obtain processed image data; and obtaining the map data for the traffic object based on the processed image data.

According to another aspect of the present disclosure, an electronic device is provided, including: at least one processor; and a memory communicatively connected to the at least one processor, wherein the memory stores instructions executable by the at least one processor, and the instructions, when executed by the at least one processor, are configured to cause the at least one processor to implement the method of processing the map data as described above.

According to another aspect of the present disclosure, a non-transitory computer-readable storage medium having computer instructions therein is provided, and the computer instructions are configured to cause a computer system to implement the method of processing the map data as described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1 schematically shows a system architecture of processing map data according to an embodiment of the present disclosure;

FIG. 2 schematically shows a flowchart of a method of processing map data according to an embodiment of the present disclosure;

FIG. 3 schematically shows a schematic diagram of acquired point cloud data according to an embodiment of the present disclosure;

FIG. 4 schematically shows a schematic diagram of processed point cloud data according to an embodiment of the present disclosure;

FIG. 5 schematically shows a diagram of mesh data according to an embodiment of the present disclosure;

FIG. 6 schematically shows a schematic diagram of processed image data according to an embodiment of the present disclosure;

FIG. 7 schematically shows a first positional relationship between a plurality of processed image data according to an embodiment of the present disclosure;

FIG. 8 schematically shows a schematic diagram of integrated image data according to an embodiment of the present disclosure;

FIG. 9 schematically shows a block diagram of an apparatus of processing the map data according to an embodiment of the present disclosure; and

FIG. 10 shows a block diagram of an electronic device for implementing a method of processing map data according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

Terms used herein are only intended to describe specific embodiments and are not intended to limit the present disclosure. Terms “include”, “comprise”, “contain”, etc. used herein indicate the presence of the described features, steps, operations and/or components, but do not exclude the presence or addition of one or more other features, steps, operations and/or components.

All terms (including technical and scientific terms) used herein have meanings generally understood by those of ordinary skilled in the art, unless otherwise defined. It should be noted that the terms used herein should be interpreted as having the meaning consistent with the context of the present disclosure, and should not be interpreted in an idealized or overly rigid manner.

In a case that an expression similar to “at least one selected from A, B, or C” is used, the expression should generally be interpreted according to the meaning of the expression generally understood by those of ordinary skilled in the art (for example, “a system having at least one selected from A, B, or C” shall include, but is not limited to, a system having A alone, having B alone, having C alone, having A and B, having A and C, having B and C, and/or having A , B and C, etc.).

When an electronic map is produced, a trajectory, a satellite image map, a point cloud, oblique photography data, etc., may be used to draw a road network information.

In a method, a common map may be produced based on a trajectory and an image, for example, a road information may be obtained based on the trajectory and the image for drawing. However, a road surface information may not be seen intuitively in this method, so it is required to continuously click to view images collected by a front-view camera so as to restore a real condition of a road surface. The process has a tedious interaction, a low operation efficiency and a low operation accuracy.

In another method, when the common map is produced, a road surface information may be drawn based on the trajectory and the satellite image map by using the trajectory and the satellite image map as a base map for a map operation. The method may obtain an overall condition of the road surface from the satellite image map, but is usually limited by an accuracy, an effect, a resolution, etc. of the satellite image map. For example, a civil satellite image map has a low resolution and a low accuracy, and has a deformation in a local region of the civil satellite image map; the satellite image map is collected from sky, and a large number of trees block the road surface information, and an overall road surface of dense forests and tunnels may be blocked and may not be seen clearly; the civil satellite image map needs to be collected by a professional satellite, which may have a high cost, require an update every few years, and have a low timeliness.

In another method, a map may be produced by using an oblique photography, for example, the ground is shot by using an unmanned aerial vehicle with a camera, and then captured images are concatenated into an image map. The images captured and acquired by the unmanned aerial vehicle have a slightly higher resolution, but a difficulty in data acquisition exists, and a problem of ground roads being blocked may not be solved.

In another method, when a high-definition map is produced, a road point cloud may be used as reference data, and a 3D vector map may be drawn with reference to a 3D road point cloud. In order to perform a three-dimensional operation of the map using the road point cloud, it is required to constantly drag and change a 3D perspective and draw 3D vector data, which may often have a low operation efficiency. The road point cloud has sparse data and a color converted by laser intensity, which may not feed back a color of a real road element. In addition, the same road section is greatly affected by lighting and a material, and a color discrimination is not as intuitive as an image.

Embodiments of the present disclosure provides a method of processing map data, including collecting sensor data for a traffic object by using an image acquisition apparatus (vehicle-mounted camera), a high-precision inertial navigation positioning device, a point cloud device, etc., where the traffic object includes, for example, a road, ground, etc. It may be possible to perform processing, such as modeling, mapping, etc., on the road ground based on the sensor data, so as to generate image data similar to a high-definition grid map of the satellite image map. The generated image data may be widely used as a base map for a production of a common map, a lane level map, and a high-definition map. The map data may be obtained by drawing vector roads on the base map, and the map data has a high-definition element. Therefore, embodiments of the present disclosure have characteristics of a high precision, a high definition and an efficient operation.

Different from drawing the map through a trajectory and an image, by using the method of processing the map data provided by embodiments of the present disclosure, a generated grid map (base map) may be more intuitive, various markings, arrows and other element information on the ground may be clearly presented, and an image of the road ground may be accurately restored by constructing a ground model, and thus the accuracy is improved.

Different from the method of producing the map by capturing images through the vehicle-mounted camera, by using the method of processing the map data provided by embodiments of the present disclosure, data may be collected from the ground at a close distance without being blocked by trees and tunnels, and the generated grid map (base map) has a larger scale and a higher definition than data obtained through the oblique photography.

Different from drawing the 3D vector map by using the road point cloud as the reference data, by using the method of processing the map data provided by embodiments of the present disclosure, the modeling and mapping technology may be used to solve a problem of sparse point cloud data, and the road surface information may be continuously presented; and, compared with a point cloud intensity color, embodiments of the present disclosure uses an image color captured by a camera, which may more truly reflect a real condition of a road surface. Therefore, compared with a point cloud three-dimensional operation, a two-dimensional top view of embodiments of the present disclosure has a characteristic of a high operation efficiency of two-dimensional road surface.

For the method of producing the map by the oblique photography, it is also possible to use obliquely captured images to be flattened to construct a top view. In contrast, embodiments of the present disclosure use a method of modeling a point cloud on the ground. Compared with the oblique photography method, which collects data in the air, embodiments of the present disclosure collect data on the ground, which may have a higher resolution without an occlusion. In addition, compared with acquiring the image through the oblique photography and acquiring the image through a looking around 360° camera for a map production, the methods of producing the map only obtain an ortho-photo map by using the image, and the ground represented is a large plane, which may not accurately describe an undulation and an unevenness of the ground. In embodiments of the present disclosure, the point cloud is modeled for a small plane, and an information about a pothole and an undulation on the ground corresponding to the small plane may be more accurately described.

The method of processing the map data provided by embodiments of the present disclosure will be described in detail below.

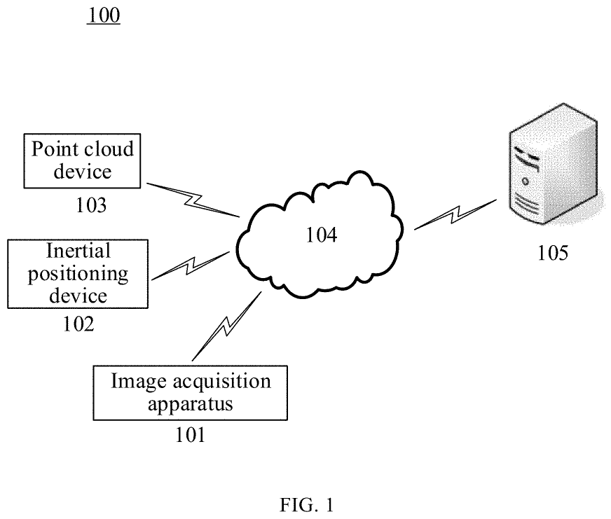

FIG. 1 schematically shows a system architecture of processing map data according to an embodiment of the present disclosure. It should be noted that FIG. 1 only shows an example of a system architecture to which embodiments of the present disclosure may be applied, so as to help those skilled in the art understand the technical content of the present disclosure, but it does not mean that embodiments of the present disclosure may not be applied to other devices, systems, environments or scenarios.

As shown in FIG. 1, a system architecture 100 according to embodiments may include data acquisition apparatuses 101, 102, 103, a network 104, and a server 105. The network 104 is a medium used to provide a communication link between the data acquisition apparatuses 101, 102, 103 and the server 105. The network 104 may include various connection types, such as wired, wireless communication links, optical fiber cables, etc.

The data acquisition apparatuses 101, 102, 103 may be various electronic devices with data acquisition functions, including but not limited to image acquisition apparatuses, inertial positioning devices, point cloud devices, etc.

The server 105 may be a server that provides various services, such as a background management server (for example only) that provides a support for a website browsed by a user using the data acquisition apparatuses 101, 102, 103. The background management server may analyze and process received data, and feedback a processing result. The server 105 may also be a cloud server, that is, the server 105 has a cloud computing function.

It should be noted that the method of processing the map data provided by embodiments of the present disclosure may be performed by the server 105. Accordingly, the apparatus of processing the map data provided by embodiments of the present disclosure may be provided in the server 105.

In an example, the data acquisition apparatuses 101, 102, 103 include sensors, and the data acquisition apparatuses 101, 102, 103 may send collected sensor data for a traffic object to the server 105 via the network 104. The server 105 may process the sensor data for the traffic object to obtain the map data for the traffic object.

It should be understood that the numbers of data acquisition devices, network and server shown in FIG. 1 are only schematic. According to implementation needs, any number of data acquisition devices, networks and servers may be provided.

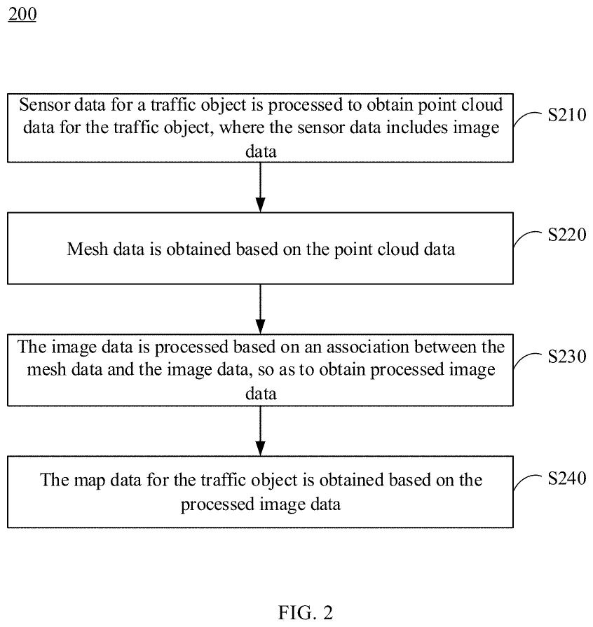

A method of processing map data according to exemplary embodiments of the present disclosure will be described below with reference to FIG. 2 to FIG. 8 in combination with the system architecture of FIG. 1. The method of processing the map data according to embodiments of the present disclosure may be performed by the server shown in FIG. 1. For example, the server is the same as or similar to an electronic device as described below.

FIG. 2 schematically shows a flowchart of a method of processing map data according to an embodiment of the present disclosure.

As shown in FIG. 2, a method 200 of processing map data according to embodiments of the present disclosure may include operations S210 to S240, for example.

In operation S210, sensor data for a traffic object is processed to obtain point cloud data for the traffic object, where the sensor data includes image data.

In operation S220, mesh data is obtained based on the point cloud data.

In operation S230, the image data is processed based on an association between the mesh data and the image data, so as to obtain processed image data.

In operation S240, the map data for the traffic object is obtained based on the processed image data.

In an example, the traffic object includes, for example, a road, a ground, etc. For example, the sensor data is collected by an image acquisition apparatus, an inertial positioning device, a point cloud device, etc.

A point cloud modeling is performed on the traffic object by processing the sensor data, so as to obtain point cloud data for the traffic object. Then, a mesh segmentation is performed on the point cloud data to obtain the mesh data. The mesh segmentation method includes, but is not limited to, a triangular mesh segmentation, a polygonal mesh segmentation, and a spline segmentation.

By pre-calibrating the image acquisition apparatus, the inertial positioning device and the point cloud device, the data collected by them are associated with each other. For example, relative positional relationships indicated by data collected by different devices are associated, or data collected by different acquisition devices are associated in time dimension. Therefore, the mesh data obtained through the processing operation and image data also have an association therebetween. The image data may be processed based on the association, so as to obtain a processed image, and the map data for the traffic object may be obtained according to the processed image, so as to achieve a production of the map data.

According to embodiments of the present disclosure, the sensor data is processed to obtain the point cloud data, then the mesh data is obtained based on the point cloud data, and then the image data is processed based on the association between the mesh data and the image data, so as to obtain the map data. Through embodiments of the present disclosure, a production cost of the map data may be reduced, and an accuracy and a production efficiency of the map data may be improved.

According to embodiments of the present disclosure, the sensor data includes, for example, image data collected by the image acquisition apparatus, and may include pose data collected by the inertial positioning device or initial point cloud data collected by the point cloud device. The image acquisition apparatus, the inertial positioning device and the point cloud device may be installed on an acquisition vehicle. The acquisition vehicle patrols to achieve a data acquisition. The acquisition vehicle includes an autonomous vehicle.

The image acquisition apparatus, the inertial positioning device and the point cloud device may be calibrated before collecting data. For example, a relative positional relationship of various devices is calibrated to calibrate internal parameters of these devices.

In addition, a clock synchronization of various devices is achieved so that these devices may collect data at the same time. Through the calibration and the clock synchronization of the devices, any two or three of collected pose data, point cloud data and image data are associated with each other based on a time information and a position information.

After the sensor data is collected, if multiple times of data are collected, it may be possible to extract a semantic feature of a road so as to obtain a same road identification based on the semantic feature, and fuse multiple trajectories for the road.

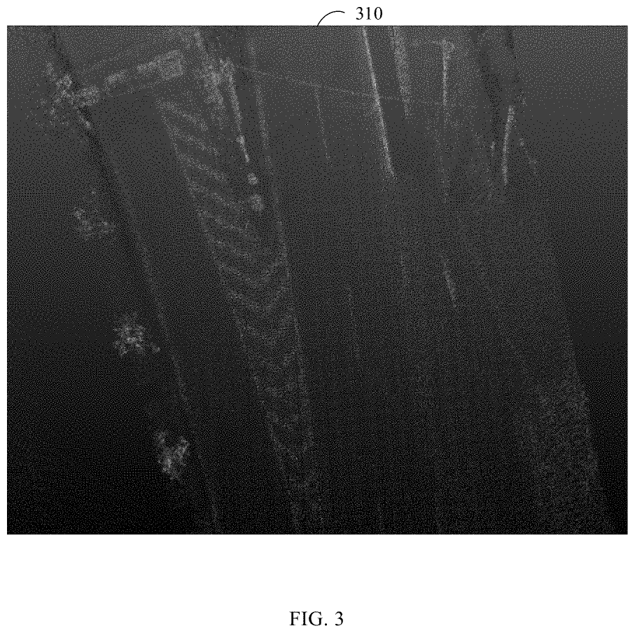

In an example, a point cloud model may be constructed based on the sensor data, so as to obtain the point cloud data, as shown in FIG. 3.

FIG. 3 schematically shows a schematic diagram of acquired point cloud data according to an embodiment of the present disclosure.

As shown in FIG. 3, point cloud data 310 for a traffic object may be constructed based on the image data collected by the image acquisition apparatus and the pose data collected by the inertial positioning device. Alternatively, the point cloud data 310 for the traffic object may be constructed based on the pose data collected by the inertial positioning device and the initial point cloud data collected by the point cloud device. For example, the point cloud data 310 is dense point cloud data.

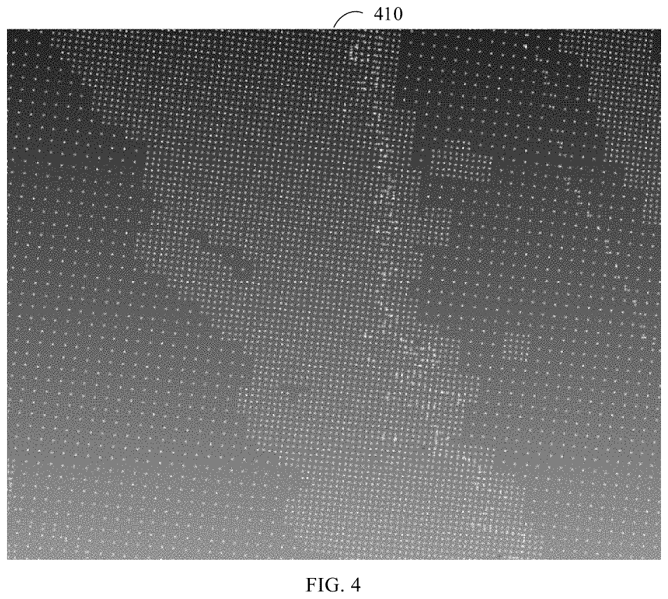

Next, a noise reduction or filtering processing is performed on the point cloud data 310. For example, taking local point cloud data shown in FIG. 3 as an example, how to process the point cloud data will be described with reference to FIG. 4.

FIG. 4 schematically shows a schematic diagram of processed point cloud data according to an embodiment of the present disclosure.

As shown in FIG. 4, as the point cloud data usually includes point cloud data for the traffic object and point cloud data for an additional object, and the point cloud data for the additional object may affect a subsequent production effect of the map data, the point cloud data for the additional object in the point cloud data may be removed by filtering or noise reduction, so as to obtain point cloud data 410 for the traffic object.

In an example, the additional object is an object higher than the ground or the road surface, such as a tree, a building, an obstacle, etc., for example. In embodiments of the present disclosure, as the map data for the road ground is produced, the object higher than the ground, such as the tree, the building, the obstacle, etc., is the additional object that needs to be removed, so as to ensure an accuracy of the map data.

Next, mesh data is obtained based on the point cloud data, as shown in FIG. 5.

FIG. 5 schematically shows a diagram of mesh data according to an embodiment of the present disclosure.

As shown in FIG. 5, after the point cloud data for the traffic object is obtained by performing filtering or noise reduction on the point cloud data, a mesh cutting may be performed based on the point cloud data for the traffic object, so as to obtain mesh data 510.

In an example, the mesh cutting includes, but is not limited to, a triangular mesh cutting, a polygonal mesh cutting, and a spline mesh cutting. In order to facilitate the understanding, the triangular mesh cutting is taken as an example in FIG. 5.

After the mesh data is obtained, a mesh surface reduction and hole filling processing may also be performed on the mesh data. The “mesh surface reduction” method is used to reduce the number of triangular meshes in the mesh, and is a mesh simplification method. A geometric information or other attributes of the mesh is maintained as much as possible while reducing the number of triangular meshes in the mesh.

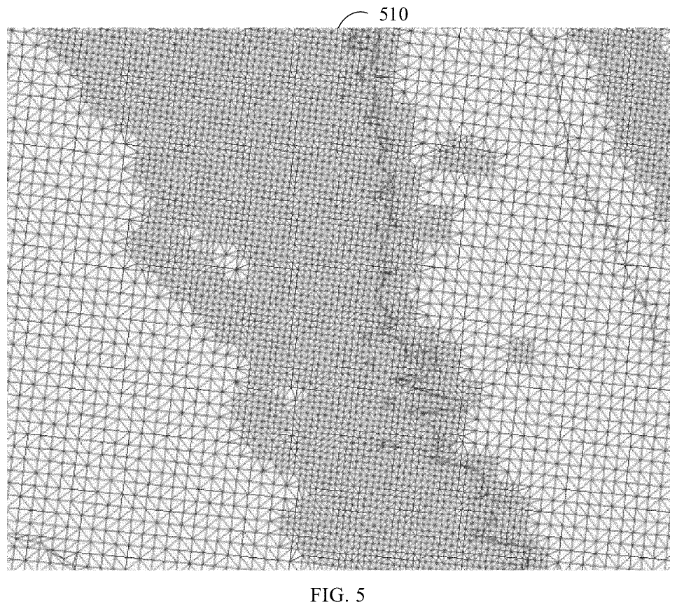

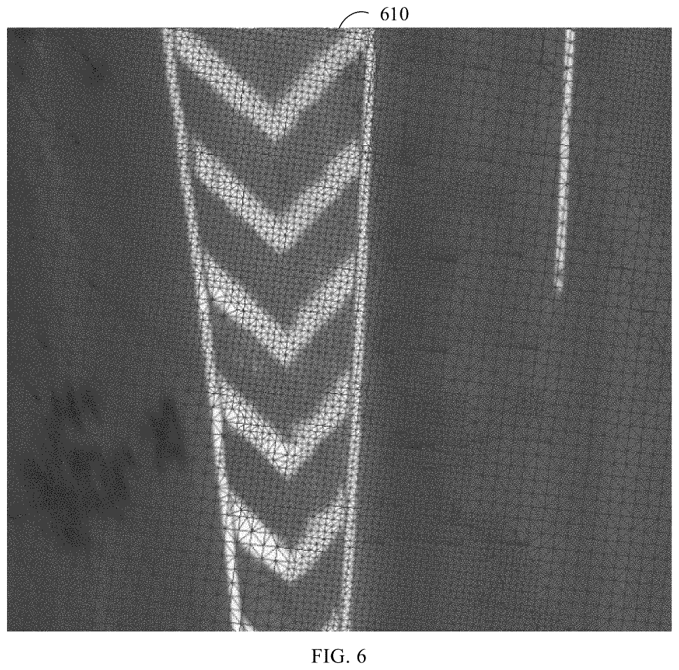

Next, the image data is processed based on the mesh data, as shown in FIG. 6.

FIG. 6 schematically shows a schematic diagram of processed image data according to an embodiment of the present disclosure.

As shown in FIG. 6, the mesh data includes mesh position data for a plurality of sub-meshes, the image data includes first image position data, and the first image position data includes, for example, position data of each pixel. Next, collected image data is processed based on an association between the mesh position data of the mesh data and the first image position data of the image data, so as to obtain processed image data 610.

For example, a plurality of sub-image data corresponding to the plurality of sub-meshes one by one is determined from the image data based on an association between the mesh position data for the plurality of sub-meshes and the first image position data. For example, position data of the sub-image data is consistent with mesh position data of a corresponding sub-mesh. Then, the plurality of sub-image data are concatenated by using the mesh position data for the plurality of sub-meshes as a reference, so as to obtain the processed image data 610.

Taking the sub-mesh as a triangular mesh as an example, each triangular mesh has three vertices. The mesh position data includes, for example, position data of the vertex. The sub-image data corresponding to each triangular mesh is determined from the image data according to an association between the position data of the vertex and the first image position data. For example, a size of each sub-image data is consistent with a size of a corresponding triangular mesh. The sub-image data is mapped and filled into the triangular mesh to obtain the processed image data 610.

According to embodiments of the present disclosure, the sub-image data are concatenated by using the mesh position data as a reference, so as to obtain the processed image data, so that the processed image data may be more accurate. Therefore, an effect of producing the map may be improved.

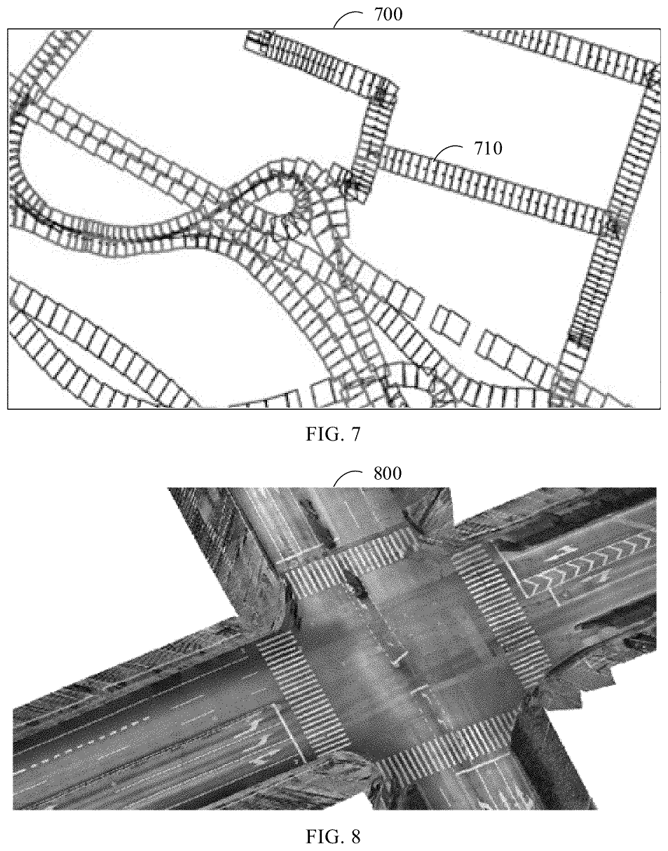

FIG. 6 shows how to obtain processed image data. A plurality of processed image data may be obtained in a similar way. Next, a first positional relationship between the plurality of processed image data is determined, as shown in FIG. 7.

FIG. 7 schematically shows a first positional relationship between a plurality of processed image data according to an embodiment of the present disclosure.

As shown in FIG. 7, the processed image data includes, for example, a plurality of processed image data, each processed image data includes second image position data, and the second image position data includes, for example, position data of four vertices of the processed image data.

In an example, the second position data of each processed image data indicates a rectangular box, for example. FIG. 7 shows second position data 710 of one processed image data. A first positional relationship 700 between the plurality of processed image data is determined based on the second image position data of the plurality of processed image data, and the first positional relationship 700 is used to represent a position distribution relationship of the plurality of processed image data.

In an example, if the first positional relationship 700 indicates that the plurality of processed image data do not have overlapping data, the plurality of processed image data may be integrated based on the first positional relationship 700, so as to obtain the integrated image data.

In another example, if the first positional relationship indicates that the plurality of processed image data have overlapping data, at least part of the plurality of processed image data is removed to obtain a plurality of target image data corresponding to the plurality of processed image data one by one. Then, a second positional relationship between the plurality of target image data is determined based on second image position data of the plurality of target image data. The plurality of target image data are integrated based on the second positional relationship, so as to obtain the integrated image data. For example, the second positional relationship is similar to first positional relationship 700.

For example, when two adjacent processed image data have duplicate data, it may be indicated that a cover relationship exists between the two adjacent processed image data. For example, when 50% of an area of one image data coincides with 50% of an area of another image data, duplicate data of one processed image data may be removed, and the duplicate data of another processed image data may not be removed, so that the area of one image data obtained is the remaining 50%, and the area of the another image data is 100%. Alternatively, a portion (30%) of the duplicate data of one processed image data may be removed, and a portion (20%) of the duplicate data of the another processed image data may be removed. It may be understood that embodiments of the present disclosure do not specifically define the method of removing duplicate data, and may be processed in any way as required.

According to embodiments of the present disclosure, the first positional relationship or the second positional relationship is determined based on the second position data of the processed image data, and the duplicate data of the processed image data is removed based on the first positional relationship or the second positional relationship, which may improve an accuracy of data integration.

FIG. 8 schematically shows a diagram of integrated image data according to an embodiment of the present disclosure.

As shown in FIG. 8, after the plurality of processed image data are integrated based on the first positional relationship, or the plurality of target image data are integrated based on the second positional relationship, integrated image data 800 is obtained. For example, the integrated image data 800 is a top view, which is similar to a high-definition grid map of a satellite image map.

In an example, the integrated image data 800 may be widely used in a production of a common map and a high-definition map.

For example, a segmentation processing may be performed on the integrated image data 800 according to a preset size, so as to obtain the map data for the traffic object. The map data for the traffic object includes, for example, a small-scale tile map. The tile map may be used as a base map for a map production, and a vector map may be obtained by drawing on the base map.

According to embodiments of the present disclosure, the sensor data for the traffic object is collected by using the image acquisition apparatus, the inertial navigation positioning device, the point cloud device, etc. Then, it may be possible to perform a processing, such as modeling, mapping, etc., on the road ground based on the sensor data so as to generate image data similar to the high-definition grid map of the satellite image map. The generated image data may be widely used as a base map for a production of a common map, a lane level map, and a high-definition map, which may improve an accuracy, a definition, and an efficiency of map data production.

Different from drawing the map through a trajectory and an image, by using the method of processing the map data provided by embodiments of the present disclosure, a generated grid map (base map) may be more intuitive, various markings, arrows and other element information on the ground may be clearly presented, and an image of the road ground may be accurately restored by constructing a ground model, and thus the accuracy is improved.

According to embodiments of the present disclosure, in a process of producing the map, data may be collected from the ground at a close distance without being blocked by trees and tunnels, and the generated grid map (base map) may be more high-definition. In addition, a problem of sparse point cloud data is solved by using a modeling and mapping technology, which may continuously present a road surface information and more truly reflect a real condition of the road surface.

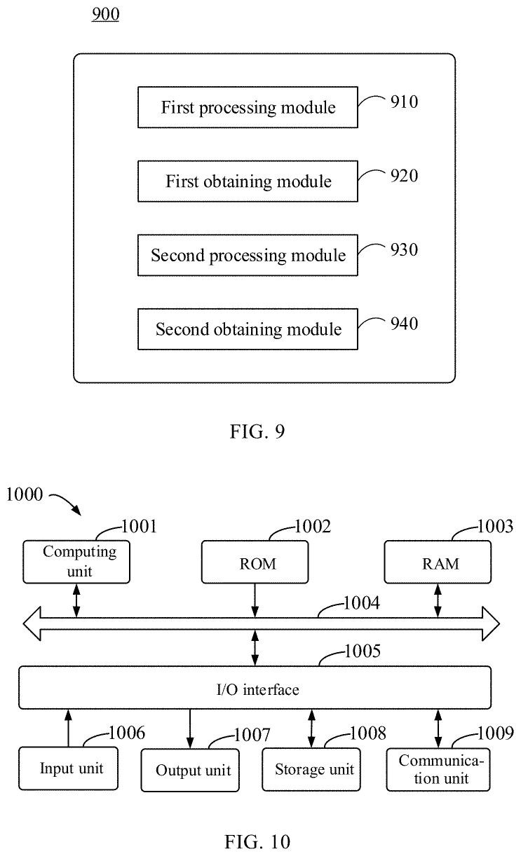

FIG. 9 schematically shows a block diagram of an apparatus of processing map data according to an embodiment of the present disclosure.

As shown in FIG. 9, an apparatus 900 of processing map data according to embodiments of the present disclosure includes, for example, a first processing module 910, a first obtaining module 920, a second processing module 930, and a second obtaining module 940.

The first processing module 910 may be used to process sensor data for a traffic object to obtain point cloud data for the traffic object, where the sensor data includes image data. According to embodiments of the present disclosure, the first processing module 910 may perform operation S210 described above with reference to FIG. 2, for example, which will not be repeated here.

The first obtaining module 920 may be used to obtain mesh data based on the point cloud data. According to embodiments of the present disclosure, the first obtaining module 920 may perform operation S220 described above with reference to FIG. 2, for example, which will not be repeated here.

The second processing module 930 may be used to process the image data based on an association between the mesh data and the image data, so as to obtain processed image data. According to embodiments of the present disclosure, the second processing module 930 may perform operation S230 described above with reference to FIG. 2, for example, which will not be repeated here.

The second obtaining module 940 may be used to obtain the map data for the traffic object based on the processed image data. According to embodiments of the present disclosure, the second obtaining module 940 may perform operation S240 described above with reference to FIG. 2, for example, which will not be repeated here.

According to embodiments of the present disclosure, the mesh data includes mesh position data for a plurality of sub-meshes, and the image data includes first image position data; and the second processing module 930 includes: a determination sub module and a concatenating sub module. The determination sub module is used to determine, from the image data, a plurality of sub-image data corresponding to the plurality of sub-meshes one by one based on an association between the mesh position data for the plurality of sub-meshes and the first image position data; and the concatenating sub module is used to concatenate the plurality of sub-image data by using the mesh position data for the plurality of sub-meshes as a reference, so as to obtain the processed image data.

According to an embodiment of the present disclosure, the point cloud data includes the point cloud data for the traffic object and point cloud data for an additional object; and the first obtaining module 920 includes: a removal sub module and a cutting sub module. The removal sub module is used to remove, from the point cloud data, the point cloud data for the additional object to obtain the point cloud data for the traffic object; and the cutting sub module is used to perform a mesh cutting based on the point cloud data for the traffic object, so as to obtain the mesh data.

According to embodiments of the present disclosure, the processed image data includes a plurality of processed image data, and each of the plurality of processed image data includes second image position data; and the second obtaining module 940 includes: an integration sub module and a segmentation sub module. The integration sub module is used to integrate the plurality of processed image data based on second image position data of the plurality of processed image data, so as to obtain integrated image data; and the segmentation sub module is used to perform a segmentation processing on the integrated image data according to a preset size, so as to obtain the map data for the traffic object.

According to embodiments of the present disclosure, the integration sub module includes: a first determination unit and a first integration unit. The first determination unit is used to determine a first positional relationship between the plurality of processed image data based on the second image position data of the plurality of processed image data; and the first integration unit is used to integrate the plurality of processed image data based on the first positional relationship so as to obtain the integrated image data, in response to determining that the first positional relationship indicates that the plurality of processed image data do not have overlapping data.

According to embodiments of the present disclosure, the integration sub module further includes: a removal unit, a second determination unit and a second integration unit. The removal unit is used to remove at least part of the plurality of processed image data to obtain a plurality of target image data corresponding to the plurality of processed image data one by one, in response to determining that the first positional relationship indicates that the plurality of processed image data have the overlapping data; the second determination unit is used to determine a second positional relationship between the plurality of target image data based on the second image position data of the plurality of target image data; and the second integration unit is used to integrate the plurality of target image data based on the second positional relationship, so as to obtain the integrated image data.

According to embodiments of the present disclosure, the sensor data further includes pose data collected by an inertial positioning device and/or initial point cloud data collected by a point cloud device, where any two or three of the pose data, the point cloud data, and the image data are associated with each other based on a time information and a position information.

In the technical solution of the present disclosure, an acquisition, a storage, a use, a processing, a transmission, a provision, a disclosure and an application of user personal information, time information, position information, etc., involved comply with provisions of relevant laws and regulations, and do not violate public order and good custom.

In the technical solution of the present disclosure, a user's authorization or consent is obtained before the user personal information is acquired or collected.

According to embodiments of the present disclosure, the present disclosure further provides an electronic device, a readable storage medium, and a computer program product.

According to embodiments of the present disclosure, a non-transitory computer-readable storage medium having computer instructions therein is provided, and the computer instructions are used to cause a computer system to implement the method of processing the map data as described above.

According to embodiments of the present disclosure, a computer program product containing a computer program/instruction is provided, and the computer program/instruction, when executed by a processor, is used to cause the processor to implement the method of processing the map data as described above.

FIG. 10 shows a block diagram of an electronic device for implementing the method of processing map data according to embodiments of the present disclosure.

FIG. 10 shows a schematic block diagram of an exemplary electronic device 1000 for implementing embodiments of the present disclosure. The electronic device 1000 is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing units 1001 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and steps described above, such as the method of processing the map data. For example, in some embodiments, the method of processing the map data may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the method of processing the map data described above. Alternatively, in other embodiments, the computing unit 1001 may be configured to perform the method of processing the map data by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable map data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trajectory ball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing map data, the method comprising:
processing sensor data for a traffic object to obtain point cloud data for the traffic object, wherein the sensor data comprises image data;
obtaining mesh data based on the point cloud data;
processing the image data based on an association between the mesh data and the image data, so as to obtain processed image data; and
obtaining the map data for the traffic object based on the processed image data.

2. The method according to claim 1, wherein the mesh data comprises mesh position data for a plurality of sub-meshes, and the image data comprises first image position data, and
wherein the processing the image data based on an association between the mesh data and the image data so as to obtain processed image data comprises:
determining, from the image data, a plurality of sub-image data corresponding to the plurality of sub-meshes one by one, based on an association between the mesh position data for the plurality of sub-meshes and the first image position data; and
concatenating the plurality of sub-image data by using the mesh position data for the plurality of sub-meshes as a reference, so as to obtain the processed image data.

3. The method according to claim 1, wherein the point cloud data comprises the point cloud data for the traffic object and point cloud data for an additional object, and
wherein the obtaining mesh data based on the point cloud data comprises:
removing the point cloud data for the additional object from the point cloud data to obtain the point cloud data for the traffic object; and
performing a mesh cutting based on the point cloud data for the traffic object, so as to obtain the mesh data.

4. The method according to claim 1, wherein the processed image data comprises a plurality of processed image data, and each of the plurality of processed image data comprises second image position data, and
wherein the obtaining the map data for the traffic object based on the processed image data comprises:
integrating the plurality of processed image data based on second image position data of the plurality of processed image data, so as to obtain integrated image data; and
performing a segmentation processing on the integrated image data according to a preset size, so as to obtain the map data for the traffic object.

5. The method according to claim 4, wherein the integrating the plurality of processed image data based on second image position data of the plurality of processed image data so as to obtain integrated image data comprises:
determining a first positional relationship between the plurality of processed image data based on the second image position data of the plurality of processed image data; and
integrating the plurality of processed image data based on the first positional relationship so as to obtain the integrated image data, in response to determining that the first positional relationship indicates that the plurality of processed image data do not have overlapping data.

6. The method according to claim 5, wherein the integrating the plurality of processed image data based on second image position data of the plurality of processed image data so as to obtain integrated image data further comprises:
removing at least part of the plurality of processed image data to obtain a plurality of target image data corresponding to the plurality of processed image data one by one, in response to determining that the first positional relationship indicates that the plurality of processed image data have the overlapping data;
determining a second positional relationship between the plurality of target image data based on second image position data of the plurality of target image data; and
integrating the plurality of target image data based on the second positional relationship, so as to obtain the integrated image data.

7. The method according to claim 1, wherein the sensor data further comprises pose data collected by an inertial positioning device and/or initial point cloud data collected by a point cloud device, and
wherein any two or three selected from: the pose data, the point cloud data, and/or the image data, are associated with each other based on a time information and a position information.

8. The method according to claim 2, wherein the point cloud data comprises the point cloud data for the traffic object and point cloud data for an additional object, and
wherein the obtaining mesh data based on the point cloud data comprises:
removing the point cloud data for the additional object from the point cloud data to obtain the point cloud data for the traffic object; and
performing a mesh cutting based on the point cloud data for the traffic object, so as to obtain the mesh data.

9. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
process sensor data for a traffic object to obtain point cloud data for the traffic object, wherein the sensor data comprises image data;
obtain mesh data based on the point cloud data;
process the image data based on an association between the mesh data and the image data, so as to obtain processed image data; and
obtain the map data for the traffic object based on the processed image data.

10. The electronic device according to claim 9, wherein the mesh data comprises mesh position data for a plurality of sub-meshes, and the image data comprises first image position data, and
wherein the instructions are further configured to cause the at least one processor to at least:
determine, from the image data, a plurality of sub-image data corresponding to the plurality of sub-meshes one by one, based on an association between the mesh position data for the plurality of sub-meshes and the first image position data; and
concatenate the plurality of sub-image data by using the mesh position data for the plurality of sub-meshes as a reference, so as to obtain the processed image data.

11. The electronic device according to claim 9, wherein the point cloud data comprises the point cloud data for the traffic object and point cloud data for an additional object, and
wherein the instructions are further configured to cause the at least one processor to at least:
remove the point cloud data for the additional object from the point cloud data to obtain the point cloud data for the traffic object; and
perform a mesh cutting based on the point cloud data for the traffic object, so as to obtain the mesh data.

12. The electronic device according to claim 9, wherein the processed image data comprises a plurality of processed image data, and each of the plurality of processed image data comprises second image position data, and
wherein the instructions are further configured to cause the at least one processor to at least:
integrate the plurality of processed image data based on second image position data of the plurality of processed image data, so as to obtain integrated image data; and
perform a segmentation processing on the integrated image data according to a preset size, so as to obtain the map data for the traffic object.

13. The electronic device according to claim 12, wherein the instructions are further configured to cause the at least one processor to at least:
determine a first positional relationship between the plurality of processed image data based on the second image position data of the plurality of processed image data; and
integrate the plurality of processed image data based on the first positional relationship so as to obtain the integrated image data, in response to a determination that the first positional relationship indicates that the plurality of processed image data do not have overlapping data.

14. The electronic device according to claim 13, wherein the instructions are further configured to cause the at least one processor to at least:
remove at least part of the plurality of processed image data to obtain a plurality of target image data corresponding to the plurality of processed image data one by one, in response to a determination that the first positional relationship indicates that the plurality of processed image data have the overlapping data;
determine a second positional relationship between the plurality of target image data based on second image position data of the plurality of target image data; and
integrate the plurality of target image data based on the second positional relationship, so as to obtain the integrated image data.

15. The electronic device according to claim 9, wherein the sensor data further comprises pose data collected by an inertial positioning device and/or initial point cloud data collected by a point cloud device, and
wherein any two or three selected from: the pose data, the point cloud data, and/or the image data, are associated with each other based on a time information and a position information.

16. A non-transitory computer-readable storage medium having computer instructions therein, wherein the computer instructions are configured to cause a computer system to at least:
process sensor data for a traffic object to obtain point cloud data for the traffic object, wherein the sensor data comprises image data;
obtain mesh data based on the point cloud data;
process the image data based on an association between the mesh data and the image data, so as to obtain processed image data; and
obtain the map data for the traffic object based on the processed image data.

17. The non-transitory computer-readable storage medium according to claim 16, wherein the mesh data comprises mesh position data for a plurality of sub-meshes, and the image data comprises first image position data, and
wherein the computer instructions are further configured to cause the computer system to at least:
determine, from the image data, a plurality of sub-image data corresponding to the plurality of sub-meshes one by one, based on an association between the mesh position data for the plurality of sub-meshes and the first image position data; and
concatenate the plurality of sub-image data by using the mesh position data for the plurality of sub-meshes as a reference, so as to obtain the processed image data.

18. The non-transitory computer-readable storage medium according to claim 16, wherein the point cloud data comprises the point cloud data for the traffic object and point cloud data for an additional object, and
wherein the computer instructions are further configured to cause the computer system to at least:
remove the point cloud data for the additional object from the point cloud data to obtain the point cloud data for the traffic object; and
perform a mesh cutting based on the point cloud data for the traffic object, so as to obtain the mesh data.

19. The non-transitory computer-readable storage medium according to claim 16, wherein the processed image data comprises a plurality of processed image data, and each of the plurality of processed image data comprises second image position data, and
wherein the computer instructions are further configured to cause the computer system to at least:
integrate the plurality of processed image data based on second image position data of the plurality of processed image data, so as to obtain integrated image data; and
perform a segmentation processing on the integrated image data according to a preset size, so as to obtain the map data for the traffic object.

20. The non-transitory computer-readable storage medium according to claim 19, wherein the computer instructions are further configured to cause the computer system to at least:
determine a first positional relationship between the plurality of processed image data based on the second image position data of the plurality of processed image data; and
integrate the plurality of processed image data based on the first positional relationship so as to obtain the integrated image data, in response to a determination that the first positional relationship indicates that the plurality of processed image data do not have overlapping data.
